(19) United States
(12) Patent Application Publication
(10) Pub. No.: US 2007/0275196 A1
(43) Pub. Date: Nov. 29, 2007

(54) Multilayer Film Having High Oxygen Transmission and High Modulus

(75) Inventor: Slawomir Opuszko, Duncan, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Cryovac, Inc.

(21) Appl. No.: 11/420,320

(22) Filed: May 25, 2006

(51) Int. Cl. B32B 27/32; B32B 27/00; B32B 1/08

(52) U.S. Cl. 428/35.2; 428/500; 428/523

(57) ABSTRACT

The invention provides a multilayer film having an oxygen transmission rate of about 10,000 cc (STP)/m²/day/atm or greater at 23° C. and 0% relative humidity, a modulus of about 15,000 psi or greater in at least one direction. The multilayer film can be used for packaging a wide variety of products requiring regulation of oxygen permeability under varying packaging conditions because the multilayer film is capable of providing a relatively high OTR without sacrificing the mechanical properties that may be necessary for many packaging applications. The multilayer film may include a sealant layer, a stiffening layer, and a core layer disposed between the sealant and stiffening layers. In one embodiment, the sealant layer comprises a polyethylene having a density of less than 0.93 g/cc; the core layer consists of an ethylene/alpha-olefin having a density of 0.90 g/cc or less; and the stiffening layer comprises a styrene/butadiene/styrene block copolymer having a modulus of about 250,000 psi.

### FIELD OF THE INVENTION

The invention relates generally to a multilayer film and more particularly to a multilayer film having a high oxygen transmission rate and modulus.

### BACKGROUND OF THE INVENTION

Polymeric films are used in a wide variety of packaging applications, including food packaging, pharmaceutical products and non-perishable consumer goods. Films suitable for each of these applications are typically required to exhibit a range of physical properties. Food packaging films in particular may be required to meet numerous demanding performance criteria, depending on the specific application. Exemplary performance criteria may include outstanding dimensional stability, i.e. a high modulus at both room and elevated temperatures, superior impact resistance, especially at low temperatures, and good transparency.

In addition to the aforementioned performance criteria, in some cases it may also be desirable to package oxygen-sensitive products with a packaging material having a desired rate of oxygen transmission. Many products may be sensitive to the amount of oxygen that is present in the package. For example, in the packaging of fresh seafood, if the packaging material does not have a relatively high oxygen transmission rate (OTR), under certain conditions the result can be the growth of clostridiyum botulinum. Such organisms can produce a serious risk of illness for a consumer of the seafood. To help prevent the growth of such organisms, the United States Food and Drug Administration requires that films used in the packaging of seafood have an oxygen (i.e., O²) transmission rate of at least 10,000 cc (STP)/m²/day/atm at 23° C. and 0% relative humidity.

Films exhibiting a relatively high oxygen transmission rate have been developed for the packaging of various oxygen-sensitive food products such as fresh produce, fruit, and cheese. Gas transmission rates for the packaging of these foods have traditionally been tailored to a desired level by making a relatively thin film (thickness generally in the range of from about 1 mil to about 1¼ mil) that contains at least one polymer having a relatively high oxygen transmission rate. Multilayer films have been developed that comprise a relatively thin outer layer that may provide abuse resistance and/or heat sealability that is adhered to a layer having high permeability layer. The high permeability layer may help to enhance the structural integrity of the film without sacrificing the oxygen transmission rate of the film. Although such films may work generally well in many circumstances, they may not meet requisite performance criteria that are necessary for certain packaging applications.

Horizontal and vertical form-fill-seal processes (HFFS and VFFS, respectively) are particularly rigorous food packaging applications. HFFS is commonly used to form flexible packaging for hot dogs, lunch meats and the like. In HFFS packaging, foodstuffs are introduced into multiple container-like pockets that have been formed across the width of a continuous roll of film (“the forming film”). The pockets are initially thermoformed and then filled as the forming film is continuously transported down a single production line. A second film (“the non-forming film”) is unwound and superposed over the forming film after it has been filled. The two films are then heat sealed at the flat surfaces surrounding the perimeter of each of the forming film pockets. The sealed pockets are then severed at the bonded flat surface, thus forming a final product suitable for sale.

In VFFS packaging, foodstuffs are introduced through a central, vertical fill tube and into a formed tubular film that has been heat-sealed transversely at its lower end. After being filled, the package, in the form of a pouch, is completed by transversely heat-sealing the upper end of the tubular segment, and severing the pouch from the tubular film above it, usually by applying sufficient heat to melt through the tube above the newly formed upper heat-seal, or by severing the sealed packages from each other at the bonded surfaces. If the films used in HFFS and VFFS packages do not have sufficient dimensional stability or modulus, the package may tend to stretch and become distorted during the severing process.

Dimensional stability is also desirable in lidding stock for semi-rigid and rigid containers. Lidding films are commonly used in conjunction with semi-rigid packages for products contained in a foam or other semi-rigid type tray. Lidding films may also be used in rigid packaging constructions, such as packaging for yogurt, custard and other dairy products contained in a rigid cup-like container. When lidding films are applied to such semi-rigid and rigid packages, heat is generally used to seal the film to the container, tray, or cup in which the product is contained. Without sufficiently high modulus, the lidding films can stretch during the lidding process, resulting in distorted printed images on the films.

Accordingly, there is a need to provide a film exhibiting a combination of sufficiently high modulus while at the same time providing the film with a relatively high oxygen transmission for the packaging of products, such as fresh seafood.

### BRIEF SUMMARY OF THE INVENTION

In one embodiment, the invention is directed to a multilayer film having a relatively high thickness and high modulus while maintaining a relatively high rate of oxygen transmission. For example, in one embodiment, the multilayer film may have an OTR of at least 5,000 cc (STP)/m²/day/atm at 23° C. and 0% relative humidity and a modulus of about 15,000 psi or greater in at least one direction. In one embodiment, the film has a relatively high OTR at a thickness greater than about 2 mils, and in some embodiments, at thickness up to about 5 mils. In other embodiments, the multilayer film has an oxygen transmission rate of at least 8,000 cc (STP)/m²/day/atm or greater at 23° C. and 0% relative humidity and a modulus of about 20,000 psi or greater in at least one direction. The multilayer film can be used in a wide variety of products under varying packaging conditions because the multilayer film is capable of providing a high oxygen transmission rate without sacrificing the mechanical properties that are necessary for certain packaging applications. As a result, the multilayer film can be used in a variety of packaging applications while reducing or eliminating damage that may occur during packaging.

In one embodiment, the multilayer film comprises an outer sealant layer, a stiffening layer, and a core layer that is disposed between the sealant and stiffening layers. The permeability, thickness and modulus of each layer are selected to provide a film having the desired OTR, package appearance, and mechanical properties.

The sealant layer comprises a polymer component having a sufficiently high OTR so that the film maintains the desired OTR. In one embodiment, the sealant layer comprises a polyethylene polymer or copolymer having a density of less than 0.93 g/cc.

In some embodiments, the core layer may help provide strength and integrity to the film. The core layer has sufficient thickness so that the core imparts the desired level of strength and integrity to the film. To maintain the desired OTR within the film, the permeability of the core layer is balanced against the thickness of the layer. It has been observed that permeability is generally related to the density of the polyethylene polymer and that lower density polyethylenes may provide improved permeability. As a result, Applicant has found that a core layer comprising a polyethylene thermoplastic elastomer, such as elastomeric ethylene/alpha-olefin copolymers having a density of less than 0.90 g/cc can be used to achieve the desired OTR while maintaining a desired strength for the film. In some embodiments, the core layer comprises a linear low density polyethylene having a density of 0.90 g/cc or less. In one embodiment, the core layer comprises an ethylene/alpha-olefin copolymer elastomer having a density of 0.895 g/cc or less.

The stiffening layer comprises a material that improves the mechanical properties of the film while maintaining a desired OTR. In one embodiment, the stiffening layer comprises a thermoplastic elastomer having an OTR of at least 7,000 cc (STP)/m²/day/atm/mil at 23° C. and 0% relative humidity and a modulus of about 200,000 psi or greater. As a result, multilayered films can be prepared that have both high OTR, excellent mechanical properties, and a relatively high thickness. For example, in one embodiment, the multilayer film may have an OTR of at least 10,000 cc (STP)/m²/day/atm at 23° C. and 0% relative humidity and a modulus of about 20,000 psi or greater in at least one direction. In one embodiment, the stiffening layer comprises a styrene-butadiene-sytrene block copolymer having an OTR of about 18,000 cc (STP)/m²/day/atm/mil at 23° C. and 0% relative humidity and a modulus of about 250,000 psi.

The high modulus stiffening layer may also help to reduce the tendency of the film to stretch or become damaged under various conditions that may be encountered in some packaging processes, such as HFFS or VFFS. In particular, the stiffening layer may help to improve the percent elongation at break of the film. In one embodiment, the multilayer film has a percent elongation at break that is between 350 and 500 percent as measured in the longitudinal direction of the film.

The multilayer film of the invention may be used in a variety of packaging applications including HFFS and VFFS. In particular, the multilayer film may be used in the packaging of oxygen-sensitive products that require a high OTR, such as fresh seafood. The film may be used not only in the production of bags and packages, but in some embodiments, may also be used as a lidstock for sealably enclosing a product on a support member, such as in a so called “case-ready package.” Accordingly, the invention may provide a multilayer film having a high OTR that can be used in a variety of packaging applications and that overcomes many of the problems that may be encountered when packaging products with some high OTR films.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a cross-sectional side view of a multilayer film that is in accordance with the invention;

FIG. 2 is a schematic illustration of an end-seal bag that has been prepared from a tubular film of the multilayer film of FIG. 1;

FIG. 3 is a transverse cross-sectional view taken through section 3-3 of FIG. 2;

FIG. 4 is an illustration of a side-seal bag that has been prepared from two sheets of the multilayer film of FIG. 1;

FIG. 5 is a transverse cross-sectional view taken through section 5-5 of FIG. 4;

FIG. 6 is an illustration of a process for making the multilayer film of FIG. 1 having heat-shrinkable attributes;

FIG. 7 is a schematic illustration of a process for making the multilayer film of FIG. 1 that does not have heat-shrinkable attributes; and

FIG. 8 illustrates a vertical form fill and seal apparatus that may be used in producing packaged products utilizing the multilayer film of the invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

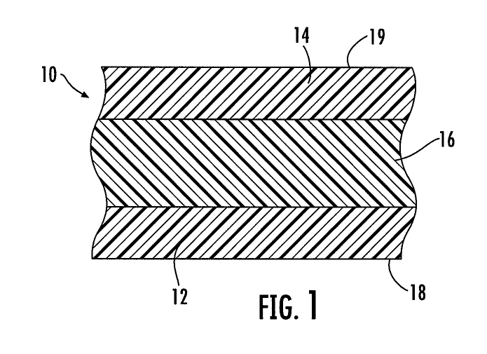

With reference to FIG. 1, a multilayer film having both a high oxygen transmission rate and modulus is illustrated and broadly designated as reference number 10. In the illustrated embodiment, the multilayered film 10 includes a first outer layer 12, also referred to as a “sealant layer”, a second outer layer 14, also referred to as a “stiffening layer”, and an inner layer 16, also referred to as a “core layer” that is disposed between the sealant layer and the stiffening layer. The core layer may be sandwiched directly between with the sealant layer 12 and the stiffening layer 14. In some embodiments, surface 18 may comprise an inner surface of a package made from the multilayer film, and surface 19 may comprise an outer or “abuse layer” for the package.

The multilayer film 10 has a sufficiently high OTR so that a desired level of oxygen may travel through the film. In some embodiments, the film 10 may have an OTR of at least 3,000, 4,000, 5,000, 6,000, 10,000, 20,000 cc (STP)/m²/day/atm or greater at 23° C. and 0% relative humidity, as measured according to ASTM D-3985. Unless otherwise indicated, all references to OTR in this application have been determined according to ASTM D-3985 at 23° C. and 0% relative humidity. To achieve the desired high OTR for the film, each individual layer of the film has a sufficiently high permeability, without sacrificing the requisite properties necessary for processing the film, and without the inclusion of perforations in the film. In addition, the multilayer film of the invention can maintain the desired level of OTR at a film thicknesses in excess of about 2 mils, and even at thicknesses up to about 5 mils.

In addition to a desired rate of OTR, the multilayer film 10 also exhibits a Young's modulus sufficient to withstand the expected processing, handling and use conditions for a wide variety of packaging applications. Young's modulus, also referred to as the modulus of elasticity, may be measured in accordance with one or more of the following ASTM procedures: D882; D5026; D4065, each of which is incorporated herein in its entirety by reference. In one embodiment, the film 10 has a Young's modulus of at least about 15,000 psi in at least one direction. In other embodiments, the multilayer film has a modulus of at least 20,000, 30,000, 50,000, 100,000, 150,000 psi or greater in at least one direction. A higher modulus film has an enhanced stiffness, which may help reduce the tendency of the film to stretch when subjected to various processing conditions, such as elevated temperatures, cutting, and the like. As a result, the film may have less of a tendency to distort or become damaged during various packaging procedures, such as those that may be encountered in VFFS or HFFS packaging. Further, it may be helpful in some embodiments that the film 10 has a high modulus at the elevated temperatures that may be present when the film 10 is exposed to heat seal temperatures, for example, during the lidstock sealing or package sealing processes discussed below.

As discussed in greater detail below, the stiffening layer 14 comprises a polymeric material having a sufficiently high modulus to impart a desired modulus to the multilayer film. In some embodiments the Young's modulus of the stiffening layer 14 may be greater than the modulus of the sealant layer 12, for example, greater by at least about one of the following amounts: 25%, 30%, 35%, 40%, 45%, 50%, 60%, 70%, 75%, 80%, 90%, 100%, 125%, 150%, 175%, 200%, 400%, and 600%.

As stated above, the multilayer film of the invention having a high OTR and high modulus may be useful in a variety of packaging applications. In particular, the multilayer film may be useful in rigorous packaging applications such as VFFS and HFFS. The high modulus of the multilayer film may permit the production of flexible packages having a high OTR without distorting or damaging the resulting package. In addition, multilayer films of the invention having an OTR in excess of 10,000 cc (STP)/m²/day/atm at 23° C. and 0% relative humidity may be advantageously useful in packaging of fresh seafood because they meet the OTR requirements of current FDA regulation.

As described in greater detail below, multilayer films prepared in accordance with the invention may be used in a variety of packaging applications including, but not limited to HFFS, VFFS, VSP, and the like. The multilayer film may also be used to prepare a wide variety of packaging structures such as pouches, bags, satchels, flexible containers, flexible packages, and the like. In the context of the invention, the terms packages, pouches, bags, satchels, flexible containers, and flexible packages are used interchangeably to refer to a package that may have a “bag- or pouch-like” shape and that at least partially comprises the multilayer film of the present invention. The multilayer films may also be used as a lidding for packages comprising a support member (e.g., tray) to which the multilayer film has been adhered. For example, in one embodiment, the multilayered film may be heat sealed to a support member to form a sealed package. Such packages may include case-ready-packages and the like.

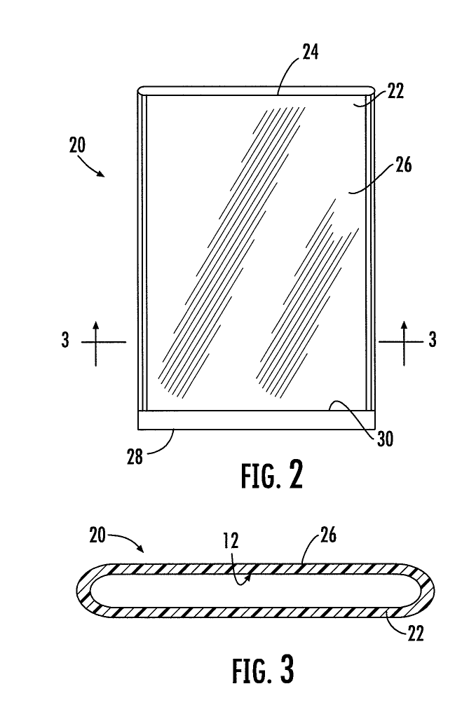

With reference to FIGS. 2 through 5, exemplary packages comprising the multilayer film of the invention are illustrated. FIG. 2 is a schematic illustration of an end seal bag 20. FIG. 3 is a cross-sectional view of bag 20 taken along line 3-3 of FIG. 2. In one embodiment, bag 20 is prepared from a seamless tubular film 22, with top edge 24 defining an open top. The seamless tubular film 22 defines a continuous sidewall 26 of the bag 20. Bottom edge 28 of the bag may be formed by separating a predefined portion of the tubular film to define a bag having a desired length. The bottom edge 28 may be closed via transverse heat seal 30 to produce a bag having continuous sidewall 26, bottom edge 28, and open top edge 24 that together define an interior space into which a product may be inserted. The top edge may be closed by a transverse heat seal to sealably enclose the product therein.

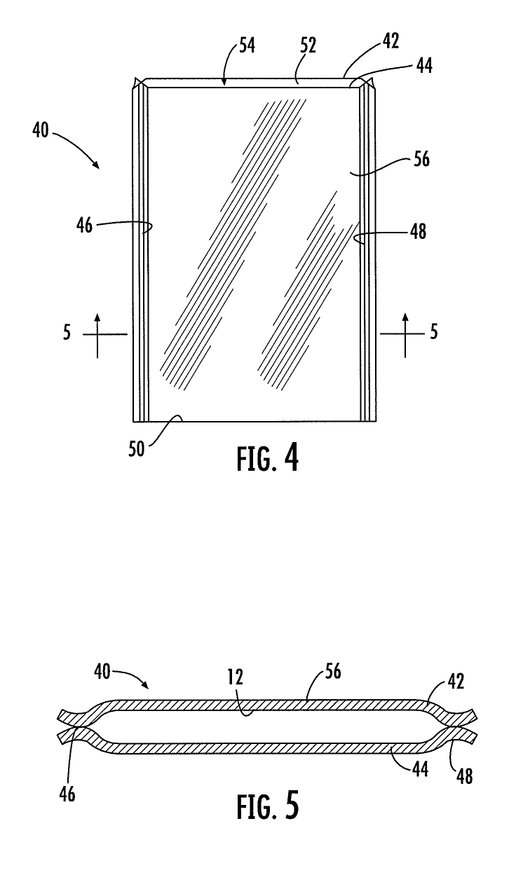

With reference to FIGS. 4 and 5, an alternative form of a bag 40 that is in accordance with the invention is illustrated. FIG. 4 is a side view of a bag 40 that is prepared be attaching first and second sheets 42, 44 of the multilayer film together along side edges 46, 48 and bottom edge 50. Open edge 52 defines an opening 54 into the interior of bag 40 into which a product may be inserted. FIG. 5 is a cross-sectional view of bag 40 viewed along line 5-5 of FIG. 4. As can best be seen in FIG. 5, bag 40 comprises two sheets of the multilayer film that are oriented in a face-to face relationship and sealed along side edges 46 and 48 to define sidewalls 56 of the bag 40. The top edge may be closed by a transverse heat seal to sealably enclose the product therein. In the embodiments illustrated in FIGS. 2-5, the multilayer film is arranged so that the sealant layer(s) (i.e., inner surface of the sealant layer, see briefly FIG. 1, reference number 18) of each side of the bag are disposed facing the interior of the bag in face-to-face relationship. As a result, the edges can be adhered together by forming a heat seal between the opposing sealant layer(s). It should be recognized that other methods may be used to form the bags, such as adhesive bonding, radio-frequency, ultrasonic bonding, and the like.

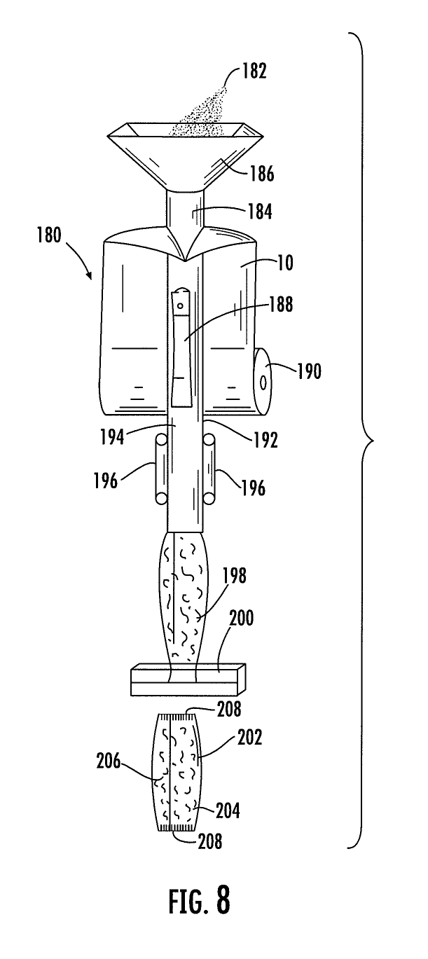

In another embodiment, the multilayer film may be used to form a package from a single sheet of the multilayer film that has been folded along its length so that the two opposing vertical edges may be adhered to each other to form a vertical seal along the length of the package (see briefly FIG. 8, reference number 202). As discussed in greater detail below, such packages are commonly formed in VFFS packaging applications.

The multilayer film comprises at least three layers wherein the composition, density, thickness, and modulus of each layer are selected to provide a multilayer film having an OTR of at least 3,000 cc (STP)/m²/day/atm at 23° C. and 0% relative humidity and a modulus of at least 15,000 psi. In some embodiments, the multilayer film has a thickness of at least about 3 mils while still maintaining an OTR of at least 10,000 cc (STP)/m²/day/atm at 23° C. and 0% relative humidity. The details of the sealant layer, core layer, and stiffening layer are discussed in greater detail below. In the context of the invention, the permeability of an individual layer within the film is determined on a per mil basis and has is expressed in OTR units of cc (STP)/m²/day/atm/mil at 23° C. and 0% relative humidity. The OTR of an individual layer is determined according to ASTM D-3985.

### Sealant Layer

In some embodiments, the sealant layer defines an outer (i.e., food side) surface 18 of the multilayer film. The sealant layer may comprise a polymeric material (i.e., component or blend of components) that facilitates the heat-sealing of film 10 to another object, such as a support member or tray, or to itself, for example, to form a pouch. The sealant layer comprises a polymeric resin or combination of polymeric resins having a permeability that is sufficient to impart a desired OTR to the sealant layer and that may be heat-sealable to a support member or to itself.

To impart the desired OTR to the film, the sealant layer may have a density of less that about 0.93 g/cc. It has been observed that the oxygen transmission rates of some polymers, such as polyethylenes, may generally be related to the density of the polymer. In general, the lower the density of polyethylene, the higher the OTR of the resulting film. In one embodiment, the sealant layer comprises a polyethylene having a density between about 0.90 to 0.93 g/cc. In one embodiment, the density polyethylenes used for the sealant layer should be less than about 0.92 g/cc so that the sealant layer has an OTR of about 7,000 cc (STP)/m²/day/atm/mil or greater at 23° C. and 0% relative humidity.

In some embodiments, the sealant layer may include selected components having a melt or softening point lower than that of the components of the other layers of the film. The sealant layer may comprise a resin having a Vicat softening temperature of less than about any of the following values: 150° C., 120° C., 115° C., 110° C., 105° C., 100° C., 95° C., and 90° C. The sealant layer may include one or more polymers having a melt-flow index of at least about any of the following: 1, 1.2, 1.4, 1.6, 1.8, 2, 2.2, 2.5, 2.8, 3, 3.5, 4, 5, 6, 7, 8, 9, 10, 15, and 20. In some embodiments, the sealant layer may include one or more polymers having a melting point of less than about any of the following: 130° C., 125° C., 120° C., and 115° C., in an amount of at least about any of the following percentages (based on the weight of the sealant layer): 30, 40, 50, 60, 70, 80, 90, and 100.

All references to “Vicat” values in this application are measured according to ASTM 1525 (1 kg). All references to melt-flow index in this application are measured according to ASTM D1238, at a temperature and piston weight as specified according to the material as set forth in the ASTM test method. All references to the melting point of a polymer or resin in this application refers to the melting peak temperature of the dominant melting phase of the polymer or resin as determined by differential scanning calorimetry according to ASTM D-3418.

The sealant layer may include one or more thermoplastic polymers including polyolefins, polystyrenes, polyurethanes, polyvinyl chlorides, and ionomers provided that the desired permeability of the sealant layer may be maintained. In one embodiment, the sealant layer comprises a thermoplastic plastomer, such as a plastomer comprising ethylene/alpha-olefin copolymer and having a density of greater than about 0.895 g/cc. In the context of the invention, the term “plastomer” refers to a homogeneous ethylene/alpha-olefin copolymer having a density in the range of from about 0.89 to about 0.93, such as from 0.90 to 0.905. Exemplary ethylene/alpha-olefin copolymer plastomers that may be used in the practice of the invention are available from Dow under the product code DPF1150.

Useful polyolefins include ethylene homo- and co-polymers and propylene homo- and co-polymers. Ethylene homopolymers may include low density polyethylene (“LDPE”) and hyperbranched ethylene polymers that are synthesized with chain walking type catalyst, such as Brookhart catalyst. Ethylene copolymers include ethylene/alpha-olefin copolymers (“EAOs”), ethylene/unsaturated ester copolymers, and ethylene/unsaturated acid copolymers. (“Copolymer” as used in this application means a polymer derived from two or more types of monomers, and includes terpolymers, etc.).

EAOs are copolymers of ethylene and one or more alpha-olefins, the copolymer having ethylene as the majority mole-percentage content. In some embodiments, the comonomer includes one or more C₃-C₂₀ alpha-olefins, more preferably one or more C₄-C₁₂ alpha-olefins, and most preferably one or more C₄-C₈ alpha-olefins. Particularly useful alpha-olefins include 1-butene, 1-hexene, 1-octene, and mixtures thereof.

EAOs include one or more of the following: 1) medium density polyethylene (“MDPE”), for example having a density of from 0.93 to 0.94 g/cm³; 2) linear medium density polyethylene (“LMDPE”), for example having a density of from 0.926 to 0.94 g/cm³; 3) linear low density polyethylene (“LLDPE”), for example having a density of from 0.915 to 0.935 g/cm³; 4) very-low or ultra-low density polyethylene (“VLDPE” and “ULDPE”), for example having density below 0.915 g/cm³; and 5) homogeneous EAOs. Useful EAOs include those having a density of less than about any of the following: 0.925, 0.922, 0.92, 0.917, 0.915, 0.912, 0.91, 0.907, 0.905, 0.903, 0.9, and 0.898 grams/cubic centimeter. Unless otherwise indicated, all densities herein are measured according to ASTM D1505.

The polyethylene polymers may be either heterogeneous or homogeneous. As is known in the art, heterogeneous polymers have a relatively wide variation in molecular weight and composition distribution. Heterogeneous polymers may be prepared with, for example, conventional Ziegler Natta catalysts.

On the other hand, homogeneous polymers are typically prepared using metallocene or other single site-type catalysts. Such single-site catalysts typically have only one type of catalytic site, which is believed to be the basis for the homogeneity of the polymers resulting from the polymerization. Homogeneous polymers are structurally different from heterogeneous polymers in that homogeneous polymers exhibit a relatively even sequencing of comonomers within a chain, a mirroring of sequence distribution in all chains, and a similarity of length of all chains. As a result, homogeneous polymers have relatively narrow molecular weight and composition distributions. Examples of homogeneous polymers include the metallocene-catalyzed linear homogeneous ethylene/alpha-olefin copolymer resins available from the Exxon Chemical Company (Baytown, Tex.) under the EXACT™, linear homogeneous ethylene/alpha-olefin copolymer resins available from the Mitsui Petrochemical Corporation under the TAFMER™, and long-chain branched, metallocene-catalyzed homogeneous ethylene/alpha-olefin copolymer resins available from the Dow Chemical Company under the AFFINITY™.

More particularly, homogeneous ethylene/alpha-olefin copolymers may be characterized by one or more methods known to those of skill in the art, such as molecular weight distribution (M_{w}/Mₙ), composition distribution breadth index (CDBI), narrow melting point range, and single melt point behavior. The molecular weight distribution (M_{w}/Mₙ), also known as “polydispersity,” may be determined by gel permeation chromatography. Homogeneous ethylene/alpha-olefin copolymers which can be used in the present invention preferably have an M_{w}/Mₙ of less than 2.7; more preferably from about 1.9 to 2.5; still more preferably, from about 1.9 to 2.3 (in contrast heterogeneous ethylene/alpha-olefin copolymers generally have a M_{w}/Mₙ of at least 3). The composition distribution breadth index (CDBI) of such homogeneous ethylene/alpha-olefin copolymers will generally be greater than about 70 percent. The CDBI is defined as the weight percent of the copolymer molecules-having a comonomer content within 50 percent (i.e., plus or minus 50%) of the median total molar comonomer content. The CDBI of linear ethylene homopolymer is defined to be 100%. The Composition Distribution Breadth Index (CDBI) is determined via the technique of Temperature Rising Elution Fractionation (TREF). CDBI determination may be used to distinguish homogeneous copolymers (i.e., narrow composition distribution as assessed by CDBI values generally above 70%) from VLDPEs available commercially which generally have a broad composition distribution as assessed by CDBI values generally less than 55%. TREF data and calculations therefrom for determination of CDBI of a copolymer may be calculated from data obtained from techniques known in the art, such as, for example, temperature rising elution fractionation as described, for example, in Wild et. al., J. Poly. Sci. Poly. Phys. Ed., Vol. 20, p. 441 (1982). Preferably, homogeneous ethylene/alpha-olefin copolymers have a CDBI greater than about 70%, i.e., a CDBI of from about 70% to 99%. In general, homogeneous ethylene/alpha-olefin copolymers useful in the present invention also exhibit a relatively narrow melting point range, in comparison with “heterogeneous copolymers”, i.e., polymers having a CDBI of less than 55%. In some embodiments, the homogeneous ethylene/alpha-olefin copolymers exhibit an essentially singular melting point characteristic, with a peak melting point (Tₘ), as determined by Differential Scanning Calorimetry (DSC), of from about 60° C. to 105° C. In one embodiment, the homogeneous copolymer has a DSC peak Tₘ of from about 80° C. to 100° C. As used herein, the phrase “essentially single melting point” means that at least about 80%, by weight, of the material corresponds to a single Tₘ peak at a temperature within the range of from about 60° C. to 105° C., and essentially no substantial fraction of the material has a peak melting point in excess of about 115° C., as determined by DSC analysis. DSC measurements are made on a Perkin Elmer System 7 Thermal Analysis System. Melting information reported are second melting data, i.e., the sample is heated at a programmed rate of 10° C./min. to a temperature below its critical range. The sample is then reheated (2nd melting) at a programmed rate of 10° C./min.

A homogeneous ethylene/alpha-olefin copolymer can, in general, be prepared by the copolymerization of ethylene and any one or more alpha-olefin. Preferably, the alpha-olefin is a C₃-C₂₀ alpha-monoolefin, more preferably, a C₄-C₁₂ alpha-monoolefin, still more preferably, a C₄-C₈ alpha-monoolefin. Still more preferably, the alpha-olefin comprises at least one member selected from the group consisting of butene-1, hexene-1, and octene-1, i.e., 1-butene, 1-hexene, and 1-octene, respectively. Most preferably, the alpha-olefin comprises octene-1, and/or a blend of hexene-1 and butene-1.

Processes for preparing and using homogeneous polymers are disclosed in U.S. Pat. No. 5,206,075, to HODGSON, Jr., U.S. Pat. No. 5,241,031, to MEHTA, and PCT International Application WO 93/03093, each of which is hereby incorporated by reference thereto, in its entirety. Further details regarding the production and use of homogeneous ethylene/alpha-olefin copolymers are disclosed in PCT International Publication Number WO 90/03414, and PCT International Publication Number WO 93/03093, both of which designate Exxon Chemical Patents, Inc. as the Applicant, and both of which are hereby incorporated by reference thereto, in their respective entireties.

Still another species of homogeneous ethylene/alpha-olefin copolymers is disclosed in U.S. Pat. No. 5,272,236, to LAI, et. al., and U.S. Pat. No. 5,278,272, to LAI, et. al., both of which are hereby incorporated by reference thereto, in their respective entireties.

Another useful ethylene copolymer is ethylene/unsaturated ester copolymer, which is the copolymer of ethylene and one or more unsaturated ester monomers. Useful unsaturated esters include: 1) vinyl esters of aliphatic carboxylic acids, where the esters have from 4 to 12 carbon atoms, and 2) alkyl esters of acrylic or methacrylic acid (collectively, “alkyl (meth)acrylate”), where the esters have from 4 to 12 carbon atoms.

Representative examples of the first (“vinyl ester”) group of monomers include vinyl acetate, vinyl propionate, vinyl hexanoate, and vinyl 2-ethylhexanoate. The vinyl ester monomer may have from 4 to 8 carbon atoms, from 4 to 6 carbon atoms, from 4 to 5 carbon atoms, and preferably 4 carbon atoms.

Representative examples of the second (“alkyl (meth)acrylate”) group of monomers include methyl acrylate, ethyl acrylate, isobutyl acrylate, n-butyl acrylate, hexyl acrylate, and 2-ethylhexyl acrylate, methyl methacrylate, ethyl methacrylate, isobutyl methacrylate, n-butyl methacrylate, hexyl methacrylate, and 2-ethylhexyl methacrylate. The alkyl (meth)acrylate monomer may have from 4 to 8 carbon atoms, from 4 to 6 carbon atoms, and preferably from 4 to 5 carbon atoms.

The unsaturated ester (i.e., vinyl ester or alkyl (meth)acrylate) comonomer content of the ethylene/unsaturated ester copolymer may range from about 3 to about 18 weight %, and from about 8 to about 12 weight %, based on the weight of the copolymer. Useful ethylene contents of the ethylene/unsaturated ester copolymer include the following amounts: at least about 82 weight %, at least about 85 weight %, at least about 88 weight %, no greater than about 97 weight %, no greater than about 93 weight %, and no greater than about 92 weight %, based on the weight of the copolymer.

Representative examples of ethylene/unsaturated ester copolymers include ethylene/methyl acrylate, ethylene/methyl methacrylate, ethylene/ethyl acrylate, ethylene/ethyl methacrylate, ethylene/butyl acrylate, ethylene/2-ethylhexyl methacrylate, and ethylene/vinyl acetate.

Another useful ethylene copolymer is ethylene/unsaturated carboxylic acid copolymer, such as a copolymer of ethylene and acrylic acid or ethylene and methacrylic acid, or both.

Useful propylene copolymer includes propylene/ethylene copolymers (“EPC”), which are copolymers of propylene and ethylene having a majority weight % content of propylene, such as those having an ethylene comonomer content of less than 10%, preferably less than 6%, and more preferably from about 2% to 6% by weight.

Ionomer is a copolymer of ethylene and an ethylenically unsaturated monocarboxylic acid having the carboxylic acid groups partially neutralized by a metal ion, such as sodium or zinc, preferably zinc. Useful ionomers include those in which sufficient metal ion is present to neutralize from about 15% to about 60% of the acid groups in the ionomer. The carboxylic acid is preferably “(meth)acrylic acid”—which means acrylic acid and/or methacrylic acid. Useful ionomers include those having at least 50 weight % and preferably at least 80 weight % ethylene units. Useful ionomers also include those having from 1 to 20 weight percent acid units. Useful ionomers are available, for example, from Dupont Corporation (Wilmington, Del.) under the SURLYN™.

The sealant layer may have a composition such that any one of the above described polymers comprises at least about any of the following weight percent values: 30, 40, 45, 50, 55, 60, 65, 70, 75, 80, 85, 90, 95, and 100% by weight of the layer.

The thickness of the sealant layer is selected to provide sufficient material to effect a strong heat seal bond, yet not so thick so as to negatively affect the OTR or the manufacture (i.e., extrusion) of the film, e.g., by lowering the melt strength of the film to an unacceptable level. The sealant layer may have a thickness of at least about any of the following values: 0.1 mils, 0.2 mils, 0.25 mils, 0.3 mils, 0.35 mils, 0.4 mils, 0.45 mils, 0.5 mils, and 0.6 mils or greater. The sealant layer may have a thickness ranging from about 0.05 to about 1.0 mils; from about 0.1 to about 0.9 mils; from about 0.1 to about 0.8 mils, and from about 0.2 to about 0.6 mils. Further, the thickness of the sealant layer as a percentage of the total thickness of the film may range (in ascending order of preference) from about 1 to about 10 percent, from about 2 to about 8 percent, and from about 4 to about 6 percent. The sealant layer may have a thickness relative to the thickness of the film of at least about any of the following values: 1%, 2%, 3%, 4%, 5%, 8%, 10% and 20%.

### Core Layer

The multilayer film may include a core layer having a high oxygen permeability. The core layer helps to provide structural support and maintain the integrity of the film without sacrificing the oxygen transmission rate of the film. In some embodiments, the core layer comprises a composition having an OTR that is greater than about 40,000 cc (STP)/m²/day/atm/mil at 23° C. and 0% relative humidity, as measured with ASTM D-3985. The OTR of the core layer may be selected from about any of the following 15,000, 18,000, 25,000, 30,000, and 40,000 cc (STP)/m²/day/atm/mil or greater at 23° C. and 0% relative humidity.

The composition of the core layer is selected to provide additional strength and integrity to the film while still maintaining a desired range of permeability. The thickness of the layer may vary provided that the film has the desired strength and OTR. The thickness of the core layer typically comprises between about 80 to 95 percent of the thickness of the film. The core layer is usually relatively thick in comparison to the sealant and stiffening layers because it helps to provide structural support and helps to maintain the integrity of the film. However, permeability of the core layer may decrease at greater thicknesses. As discussed above, OTR is generally related to the density of the polymeric material from which the layer is comprised. To help maintain the desired OTR of the core layer without sacrificing the strength provided by the core layer, the core layer may comprise a low density polymeric material. The Applicant has found that a core layer comprising an ethylene/alpha-olefin having a density of less than about 0.90 g/cc may provide sufficient permeability at greater thicknesses. As a result, a multilayer film may be produced having good strength and high OTR.

Suitable compositions for the core layer may include many of the compositions described above in connection with the sealant layer provided that the integrity of the film is maintained without sacrificing the desired oxygen transmission rate of the multilayer film. Exemplary compositions may include low-density polyethylenes such as LLDPE, ULDPE, VLDPE; metallocene polyethylene such as metallocene VLDPE and metallocene ULDPE, and blends thereof. In one embodiment, the core layer comprises an ethylene/alpha-olefin copolymer having a density of less than about 0.90 g/cc. In one embodiment, the core layer comprises a thermoplastic elastomer, such as an elastomer comprising ethylene/alpha-olefin copolymer and having a density of less than about 0.89 g/cc. In the context of the invention, the term “elastomer” refers to an ethylene/alpha-olefin copolymer having a density in the range of from about 0.85 to about 0.89, such as from 0.860 to 0.885. Exemplary ethylene/alpha-olefin copolymer elastomers that may be used in the practice of the invention are available from Dow under the tradename Engage®.

As discussed above, the thickness of the core layer may be selected to provide a film having a desired strength and OTR. In some embodiments, the core layer has a thickness that is about 80 to 95 percent of the overall thickness of the film. For higher OTR applications, the core layer may have a thickness from about 90 to 95 percent of the overall thickness of the film. In embodiments where a high modulus is desired, the core layer may have a thickness that is from about 80 to 90 percent of the overall thickness of the film. The core layer may have a thickness of at least about any one of the following: 1.2 mils. 1.4 mils, 1.6 mils, 1.8 mils, 2.0 mils, 2.2 mils, 2.4 mils, 2.6 mils, 2.8 mils, 3.0 mils, 3.2 mils, 3.4 mils, 3.6 mils, 3.8 mils, 4.0 mils, 4.2 mils, or 4.4 mils. 4.6 mils, 4.8 mils, or greater. In one embodiment, the core layer may have a thickness ranging from about 1.2 to 4. mils, from about 1.3 to 4.5 mils, from about 1.4 to 4.0 mils, from about 1.4 to 3.0 mils, from about 1.45 to 2.5 mils, from about 1.5 to 2.0 mils, and from about 1.5 to 1.9 mils. In another embodiment, the core layer has a thickness from about 1.3 to 2.0 mils. The core layer may have a thickness relative to the total thickness of the film of at least about any of the following values: 80%, 82%, 84%, 86%, 88%, 90%, 92%, 94%, and 95%.

### Stiffening Layer

To help improve the stiffness of the film, the film includes a stiffening layer having a high modulus and a high OTR. In one embodiment, the stiffening layer has sufficient stiffness so that the film may be amendable to various packaging applications. Inadequate stiffness may result in difficulties during the packaging process and/or possible defects in the resulting package. In the context of this application, the term “stiffness” refers to the ability of the film to resist undesired extension facilitated by tension, or force, and temperatures imposed on the film by the packaging equipment. The stiffness of the film or a layer of the film may be correlated to the modulus of the film or layer. In one embodiment, multilayer films having acceptable stiffness may have a modulus that is at least 15,000 pounds per square inch (psi) or greater as measured according to ASTM D-882.

To achieve the desired stiffness within the film, the stiffness of the stiffening layer as determined in terms of modulus is typically from about 100,000 to 200,000 psi with a modulus from about 150,000 to about 175,000 being somewhat more typical. In some embodiments, the stiffening layer has a modulus of about 250,000 psi or greater. As a result, multilayer films may be prepared in accordance with the invention having a modulus exceeding 15,000, 20,000, 30,000, 40,000, 50,000 and even 70,000 psi.

The stiffening layer may help to improve the stiffness of the film while still maintaining a sufficiently high permeability. The stiffening layer typically has a permeability of at least about 7,000 cc (STP) mil/m²/day/atm/mil at 23° C. and 0% relative humidity as measured with ASTM D-3985. In some embodiments, the permeability of the stiffening layer is from about 7,000 to 20,000 cc (STP)/m²/day/atm/mil at 23° C. and 0% relative humidity, with 8,000 to 18,000 cc (STP) mil/m²/day/atm or greater at 23° C. and 0% relative humidity being somewhat more typical. In one embodiment, the stiffening layer has an OTR of about 18,000 cc (STP)/m²/day/atm/mil or greater at 23° C. and 0% relative humidity.

The thickness of the stiffening layer may be varied provided that the desired stiffness of the film and rate of oxygen transmission through the stiffening layer is maintained. In some embodiments, the stiffening layer has a thickness that is about 1 to 20 percent of the overall thickness of the film. For higher OTR applications, the stiffening layer may have a thickness from about 1 to 5 percent of the overall thickness of the film. In embodiments where a high modulus is desired, the stiffening layer may have a thickness that is up to about 20 percent of the overall thickness of the film. The stiffening layer may have a thickness of at least about any one of the following: 0.05 mils. 0.1 mils, 0.15 mils, 0.20 mils, 0.22 mils, 0.25 mils, 0.30 mils, 0.35 mils, 0.40 mils, 0.45 mils, 0.50 mils, 0.55 mils, 0.60 mils, 0.70 mils, 0.80 mils, 0.90 mils, or 1.0 mils or greater. In one embodiment, the stiffening layer has a thickness ranging from about 0.10 to 1.0 mils, from about 0.2 to 0.8 mils, from about 0.3 to 0.7 mils, and from about 0.4 to 0.6 mils. The stiffening layer may have a thickness relative to the thickness of the film of at least about any of the following values: 1%, 2%, 3%, 4%, 5%, 8%, 10%, and 20%.

Suitable materials for the stiffening layer may include thermoplastic styrenic rubbers, (“TPSR”) having both the desired OTR and modulus. The term “thermoplastic styrenic rubber” refers generally to block copolymers incorporating at least one block of a styrenic monomer into the polymer chain, which at room temperature, can be stretched repeatedly to at least twice its original length, and that does not require curing or vulcanization to achieve their desired properties. In one embodiment, the stiffening layer comprises a styrenic thermoplastic elastomer having an OTR of at least 7,000 cc (STP)/m²/day/atm/mil or greater at 23° C. and 0% relative humidity and a modulus of at least 200,000 psi. Suitable TPSRs may include: styrene/ethylene/butylenes/styrene copolymer (SEBS), styrene/butadiene/styrene copolymer (SBS), styrene/isoprene/styrene copolymer (SIS), and polystyrene (PS), and combinations thereof. In one embodiment, the thermoplastic styrenic rubber comprises SBS having an OTR of about 18,000 cc (STP)/m²/day/atm/mil or greater at 23° C. and 0% relative humidity and a modulus of about 250,000 psi.

Styrenic thermoplastic elastomers having a high modulus also typically exhibit a reduction in the percent elongation at break. In many packaging applications it may be desirable to use films having a lower percent elongation at break so that the film may be more easily processed in rigorous packaging applications, such as VSSF or HFFS. As discussed above, films of insufficient modulus may be damaged or distorted during certain packaging procedures. In some embodiments, the multilayer film has a percent elongation at break that is less than 500, 450, 400, and 350 percent in the longitudinal direction of the film. In one particularly useful embodiment, the multilayer film of the invention has a percent elongation at break that is less than 350 percent in the longitudinal direction of the film. Unless otherwise indicated, all elongation at break values herein are measured according to ASTM D882.

In some embodiments, the stiffening layer may also comprise an outer surface of the multilayer film. As such, the stiffening layer may also serve as an abuse layer for a package produced using the multilayer film. The stiffening layer may also provide a surface upon which a printed indicia may be applied. Printed indicia may include product information, branding, price, instructions, shelf-like information, and the like.

In one embodiment, the multilayer film of the invention includes at least three layers. It should be recognized that the multilayer film may include additional layers, e.g., 3-8, 3-6, or 3-4 layers, provided that the desired OTR and modulus of the film is maintained. In some embodiments, the multilayer film may include one or more tie layers, additional bulk layers, an outer abuse layer, or combinations thereof. Several particularly useful 3-layer film structures that are in accordance with the present invention are disclosed below in Examples 1-6.

In addition to the high OTR and modulus properties discussed above, the multilayer film of the invention may also have desirable optical properties. Optical properties, such as gloss, haze, and transmission, may be particularly important in the packaging of food products. In many cases, the consumer may want to visually inspect the food item before making a purchasing decision. If the consumer is unable to adequately view the product through the package the consumer may decide against purchasing that product.

In general, multilayer films comprising dissimilar materials, such as SBS and LLDPE, may exhibit undesirable optical properties. For example, some multilayer films comprising different polymeric components may exhibit high haze, low gloss and a matte appearance. Such properties may be undesirable in the packaging of food products. The multilayer films of the invention posses many desirable properties such as low haze, high gloss characteristics, and good transparency. As a result, the multilayer films of the invention are particularly suited for the packaging of a wide variety of food products.

In general, haze relates to the optical clarity of the film. Haze is caused by back scatter of light and may be generated either at the film surface or within the interior of the film. Hence the total haze exhibited by a film includes both surface haze and internal haze. Films exhibiting total and/or internal haze values of about 10% per mil or less are considered to provide good optical quality. Films exhibiting total haze values of about 5% per mil or less are considered to provide superior optical quality. In some embodiments, the multilayer film has a haze value of less than 6, 5, 4, 3, and 2% per mil. In one embodiment, the multilayer film has a haze value between 1.5 and 2.5% per mil. Unless otherwise indicated, all haze values herein are measured according to ASTM D1003.

Gloss is a measure of the light reflected by the surface of a material. In many food packaging applications it may be desirable to have a high gloss package, which may be appealing to a consumer. In one embodiment, the multilayer film has a gloss value between 50 and 100. In other embodiments, the multilayer film has a gloss value of greater than 70, 75, 80, 90, and 95. Unless otherwise indicated, all gloss values herein are measured according to ASTM D2457.

The multilayer film of the invention also has good light transmission properties. In one embodiments, the multilayer film has a light transmission of greater than 90, 91, 92, 93, and 94%. Unless otherwise indicated, all light transmission values herein are measured according to ASTM D1003.

The multilayer film of the present invention can have any total thickness desired, so long as the film provides the desired properties for the particular packaging operation in which the film is used. The film of the present invention generally has a total thickness of less than about 10 mils, such as less than 6 mils. In some embodiment, the film used in the present invention has a total thickness (i.e., a combined thickness of all layers), from about 1.5 to 5 mils (1 mil is 0.001 inch); from about 1.5 to 3.5 mils; from 1.8 to 2.5 mils, and from 1.9 to 2.2 mils. In another embodiment, the film has a total thickness ranging between 2 to 3 mils, such as between 2.5 to 3 mils.

One or more layers of the multilayer film 10 may include one or more additives useful in packaging films, such as, antiblocking agents, slip agents, antifog agents, colorants, pigments, dyes, flavorants, antimicrobial agents, meat preservatives, antioxidants, fillers, radiation stabilizers, and antistatic agents. Such additives, and their effective amounts, are known in the art.

An antifog agent may advantageously be incorporated into sealant layer 12 or coated onto sealant layer 12. Sealant layer 12 forms the inner layer adjacent the interior of the sealed packages 20, 40 (see briefly FIGS. 3 and 5). Suitable antifog agents may fall into classes such as esters of aliphatic alcohols, esters of polyglycol, polyethers, polyhydric alcohols, esters of polyhydric aliphatic alcohols, polyethoxylated aromatic alcohols, nonionic ethoxylates, and hydrophilic fatty acid esters. Useful antifog agents include polyoxyethylene, sorbitan monostearate, polyoxyethylene sorbitan monolaurate, polyoxyethylene monopalmitate, polyoxyethylene sorbitan tristearate, polyoxyethylene sorbitan trioleate, poly(oxypropylene), polyethoxylated fatty alcohols, polyoxyethylated 4-nonylphenol, polyhydric alcohol, propylene diol, propylene triol, and ethylene diol, monoglyceride esters of vegetable oil or animal fat, mono- and/or diglycerides such as glycerol mono- and dioleate, glyceryl stearate, monophenyl polyethoxylate, and sorbitan monolaurate. The antifog agent is incorporated in an amount effective to enhance the antifog performance of the multilayer film 10.

### Optional Energy Treatment of the Sealant and/or Print Films

One or more of the thermoplastic layers of the multilayer film—or at least a portion of the multilayer film—may optionally be cross-linked to improve the strength of the film, improve the orientation of the film, and improve resistance to burn through during heat seal operations. Cross-linking may be achieved by using chemical additives or by subjecting one or more film layers to one or more energetic radiation treatments—such as ultraviolet, X-ray, gamma ray, beta ray, and high energy electron beam treatment—to induce cross-linking between molecules of the irradiated material. Useful radiation dosages include at least about any of the following: 5, 7, 10, 15, 20, 25, 30, 35, 40, 45, and 50 kGy (kiloGray). Useful radiation dosages include less than about any of the following: 130, 120, 110, 100, 90, 80, and 70 kGy (kiloGray). Useful radiation dosages include any of the following ranges: from 5 to 150, from 10 to 130, from 5 to 100, and from 5 to 75 kGy.

All or a portion of one or two surfaces the multilayer film may be corona and/or plasma treated to modify the surface energy of the film, for example, to increase the ability to print the film. One type of oxidative surface treatment involves bringing the multilayer film into the proximity of an O₂- or N₂-containing gas (e.g., ambient air) which has been ionized. Exemplary techniques are described in, for example, U.S. Pat. No. 4,120,716 (Bonet) and U.S. Pat. No. 4,879,430 (Hoffman), which are incorporated herein in their entirety by reference. The multilayer film may be treated to have a surface energy of at least about 0.034 J/m², preferably at least about 0.036 J/m², more preferably at least about 0.038 J/m², and most preferably at least about 0.040 J/m².

Multilayer film 10 may also have a heat-shrink attribute which may come into effect upon exposure to the elevated temperatures associated with sealing the film to itself or a support member. The film may have any of a free shrink in at least one direction (machine or transverse direction), in at least each of two directions (machine and transverse directions), or a total free shrink of at least about any of the following values: 10%, 12%, 14%, 16%, 18%, 20%, and 25% when measured at 200° F.; and at least about 21%, 23%, 25%, 30%, 35%, and 40% when measured at 240° F. In one embodiment, the multilayer film has a total free shrink at 185° F. of from about 50 to 115 percent. It is believed that heat sealing a film to a support member (e.g., tray) where the film exhibits total free shrink values of 50 to 130 percent at either or both 200° F. and 240° F. reduces the number and severity of wrinkles and/or waves that may otherwise form in the lid of the resulting sealed package. The “free shrink” of the film is determined according to ASTM D 2732, as set forth in the 1009 Annual Book of ASTM Standards, Vol. 08.02, pp. 369-371, which is hereby incorporated by reference in its entirety.

### Manufacture of the Multilayer Film

The multilayer film may be manufactured by thermoplastic film-forming processes known in the art (e.g., tubular or blown-film extrusion, coextrusion, extrusion coating, flat or cast film extrusion). A combination of these processes may also be employed. In some embodiments, the multilayer film is coextruded. Suitable methods of coextrusion include any extrusion method employing a heated die, such as a T-die or annular die. As known in the art, multi-layer T-die methods are generally used to form wide web films. Annular dies are typically used to form tubular films, generally by inflation methods. The mechanical properties of the high modulus layer may be improved by stretching the film at an elevated temperature, such as a temperature at least 10 to 30° C. above the glass transition temperature of one or more major polymer constituents of the layers. Such stretch orientation is known to particularly improve the elongation at break of the high modulus layer. Coextruded wide web films may be unoriented, uniaxially oriented or biaxially oriented, as known in the art. Films formed by inflation methods are generally biaxially oriented.

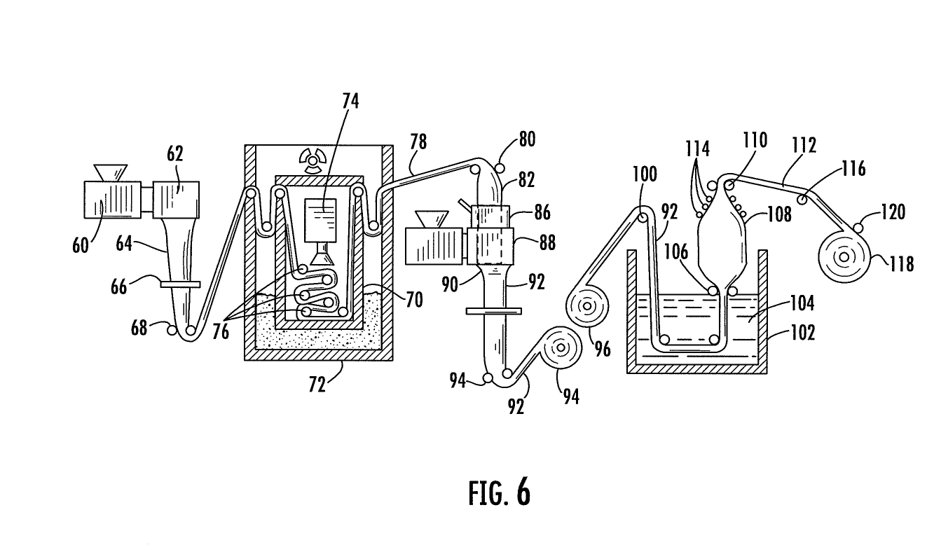

With reference to FIG. 6, an exemplary process for manufacturing a multilayer film that is in accordance with the invention is illustrated. FIG. 6 illustrates a process for manufacturing a multilayer film having heat-shrinkable attributes. In the process illustrated in FIG. 6, solid polymer beads (not illustrated) are fed to a plurality of extruders 60 (for simplicity, only one extruder is illustrated). Inside extruders 60, the polymer beads are forwarded, melted, and degassed, following which the resulting bubble-free melt is forwarded into die head 62, and extruded through an annular die, resulting in tubing 64 which may be about 8 to 16 mils thick, or from about 10 to 14 mils thick.

After cooling or quenching by water spray from cooling ring 66, tubing 64 is collapsed by pinch rolls 68, and is thereafter fed through irradiation vault 70 surrounded by shielding 72, where tubing 64 is irradiated with high energy electrons (i.e., ionizing radiation) from a iron core transformer accelerator 74, for example. Tubing 64 is guided through irradiation vault 70 on rolls 76. In some embodiments, tubing 64 is irradiated to a level of about 60 to 70 kiloGrays (kGy).

After irradiation, irradiated tubing 78 is directed through nip rolls 80, following which tubing 78 is slightly inflated, resulting in slightly inflated tubing 82 which contains a trapped bubble of air. However, slightly inflated tubing 82 may not be significantly drawn longitudinally, as the surface speed of nip rolls 84 may be about the same speed as nip rolls 80. Furthermore, slightly inflated tubing 82 may only be inflated enough to provide a substantially circular tubing without significant transverse orientation, i.e., without stretching.

The slightly inflated, irradiated tubing 82 may then be passed through a vacuum chamber 86, and thereafter forwarded through a coating die 88. Second tubular film 40 is melt extruded from coating die 88 and coated onto slightly inflated, irradiated tube 82, to form multiply tubular film 92. Further details of the above-described coating step are generally as set forth in U.S. Pat. No. 4,278,738, to BRAX et al., which is hereby incorporated by reference thereto, in its entirety.

After irradiation and coating, multi-ply tubing film 92 may be wound up onto windup roll 94. Thereafter, windup roll 94 is removed and installed as unwind roll 96, on a second stage in the process of making the tubing film as ultimately desired. Multi-ply tubular film 92, from unwind roll 96, is unwound and passed over guide roll 100, after which multi-ply tubular film 92 passes into hot water bath tank 102 containing hot water 104. The now collapsed, irradiated, coated tubular film 92 is submersed in hot water 104 (having a temperature of about 200° F.) for a retention time of at least about 5 seconds, i.e., for a time period in order to bring the film up to the desired temperature for biaxial orientation. Thereafter, irradiated tubular film 92 is directed through nip rolls 106, and bubble 108 is blown, thereby transversely stretching tubular film 92. Additionally, while being blown, i.e., transversely stretched, nip rolls 110 draw tubular film 92 in the longitudinal direction, as nip rolls 110 have a surface speed higher than the surface speed of nip rolls 106. As a result of the transverse stretching and longitudinal drawing, partially-irradiated, coated, biaxially-oriented blown tubing film 112 is produced, this blown tubing preferably having been both stretched in a ratio of from about 1:1.5-1:6, and drawn in a ratio of from about 1:1.5-1:6. In some embodiments, the stretching and drawing are each performed a ratio of from about 1:2-1:4. The result is a biaxial orientation of from about 1:2.25-1:36, and in some embodiments, from about 1:4-1:16. While bubble 108 is maintained between pinch rolls 106 and 110, blown tubing film 112 is collapsed by rolls 114, and thereafter conveyed through nip rolls 110 and across guide roll 116, and then rolled onto wind-up roll 118. Idler roll 120 helps to assist in the wind-up of the film.

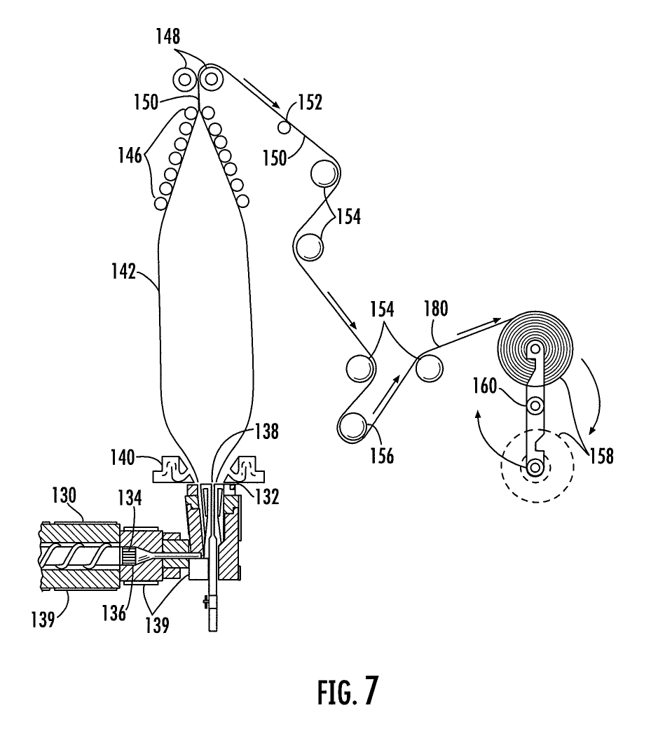

FIG. 7 illustrates a schematic view of an exemplary process that may be used for producing a non-heat-shrinkable, hot-blown multilayer film in accordance with the present invention. This film is called “hot-blown” because the polymer is oriented in the bubble immediately downstream of the die head, while the polymer is hot, i.e., above, at, or near its melting point, at which time molecular orientation can occur while the polymer chains remain relaxed (versus orientation at or near the softening point, as used in heat-shrinkable film process of FIG. 6).

Although for the sake of simplicity only one extruder 130 is illustrated in FIG. 7, there may be at least 2 extruders or more. In some embodiments, there may be at least three extruders. The one or more extruders supply molten polymer to coextrusion die 132 for the formation of, for example, outer sealant layer of the film and at least one additional extruder (not illustrated) supplied molten polymer to coextrusion die 132 for the formation of, for example, the core layer or the stiffening layer of the film. Each of the extruders is supplied with polymer pellets (not shown) suitable for the formation of the respective layer it is extruding. The extruders subject the polymer pellets to sufficient pressure and heat to melt the polymer and thereby prepare it for extrusion through a die.

Taking extruder 130 as an example, each of the extruders may include a screen pack 134, a breaker plate 136, and a plurality of heaters 139. Each of the coextruded film layers is extruded between mandrel 138 and die 132, and the extrudate is cooled by cool air flowing from air ring 140. The resulting blown bubble 142 is thereafter guided into a collapsed configuration by nip rolls 148, via guide rolls 146. Collapsed film tubing 150 (in lay-flat configuration) is optionally passed over treater bar 152, and is thereafter passed over one or more idler rolls 154, and around dancer roll 156 which imparts tension control to collapsed tube 150, after which collapsed film tubing is wound into roll 158 via winding mechanism 160. The multilayer film is may now be stored, shipped, or used in a subsequent packaging procedure.

Although not illustrated, the multilayered film prepared in FIG. 7, may be irradiated. As discussed above, the irradiation process subjects the film to an energetic radiation treatment, such as corona discharge, plasma, flame, ultraviolet, X-ray, gamma ray, beta ray, and high energy electron treatment, which induce cross-linking between molecules of the irradiated material.

With reference to FIG. 8 a vertical form fill and seal (VFFS) apparatus that may be used in a packaging process according to the present invention is illustrated. Vertical form fill and seal equipment is well known to those of skill in the packaging arts. The following documents disclose a variety of equipment suitable for vertical form fill and seal: U.S. Pat. Nos. 2,956,383; 3,340,129 to J. J. GREVICH; U.S. Pat. No. 3,611,657, to KIYOSHI INOUE, et. al.; U.S. Pat. No. 3,703,396, to INOUE, et. al.; U.S. Pat. No. 4,103,473, to BAST, et. al.; U.S. Pat. No. 4,506,494, to SHIMOYAMA, et. al.; U.S. Pat. No. 4,589,247, to TSURUTA et al.; U.S. Pat. No. 4,532,752, to TAYLOR; U.S. Pat. No. 4,532,753, to KOVACS; U.S. Pat. No. 4,571,926, to SCULLY; and Great Britain Patent Specification No. 1, 334 616, to de GROOT, et. al., each of which is hereby incorporated in its entirety, by reference thereto.

In FIG. 8, a vertical form fill and seal apparatus 180 is schematically illustrated. Apparatus 180 utilizes multilayer film 10 according to the invention. Product 182, to be packaged, is supplied to apparatus 180 from a source (not illustrated), from which a predetermined quantity of product 182 reaches upper end portion of forming tube 184 via funnel 186, or other conventional means. The packages are formed in a lower portion of apparatus 180, and flexible sheet material 10 from which the bags or packages are formed is fed from roll 190 over certain forming bars (not illustrated), is wrapped about forming tube 184, and is provided with longitudinal seal 192 by longitudinal heat sealing device 188, resulting in the formation of vertically-oriented tube 194. End seal bars 200 operate to close and seal horizontally across the lower end of vertically-sealed tube 194, to form pouch 198 which is thereafter immediately packed with product 182. Film drive belts 196, powered and directed by rollers, as illustrated, advance tube 194 and pouch 198 a predetermined distance, after which end seal bars 200 close and simultaneously seal horizontally across the lower end of vertically-sealed tube 48 as well as simultaneously sealing horizontally across upper end of sealed pouch 202, to form a product packaged in sealed pouch 202. The next pouch 198, thereabove, is then filled with a metered quantity of product 182, forwarded, and so on. It is also conventional to incorporate with the end seal bars a cut-off knife (not shown) which operates to sever a lower sealed pouch 202 from the bottom of upstream pouch 198.

In carrying out the packaging process of the present invention, the vertical form fill and seal machine may form, fill, and seal at least 15 packages per minute. In some embodiments, vertical form fill and seal machine may process from about 15 to 45 packages per minute, without substantial burn through of the film at the seals. In this regard, the high modulus of the multilayer film may permit the high speed processing of the film while reducing damage or distortion of the resulting sealed pouch as a result of the sealing and cutting steps. As discussed above, the multilayer film has an elongation at break that may be less than about 500 percent, and in some embodiments less than about 480, 460, 440, 400, 380, 350, and even less than 340 percent. As a result, the multilayer film of the invention has good processing characteristics that make it particularly useful in rigorous packaging applications such as VFFS or HFFS.

In some embodiments, the multilayered film may be sealed at the lowest possible temperature at which relatively strong seals are produced. In general, the film may be sealed at a temperature of from about 70° C. to 150° C.; in other embodiments, from about 80° C. to 140° C., and in still other embodiments, from about 90° C. to 130° C.

FIG. 8 illustrates one embodiment of a packaged product 202 of the present invention, the product being packaged in sealed pouch 204 having vertical seal 206 and end seals 208. In one embodiment, package 202 comprises a multilayer film having an OTR of at least 3,000 and a modulus of at least 15,000 psi.

In one embodiment, the packaging process is carried out with the packaging of an oxygen-sensitive product. In some embodiments, the packaging process is carried out with a product requiring oxygen permeability, such a fresh seafood product, for example, fresh fish. In the packaging of fresh seafood, it is desirable that the film have an OTR of at least 10,000 cc (STP)/m²/day/atm or greater at 23° C. and 0% relative humidity. In other embodiments, the oxygen sensitive product may comprise a vegetable or fruit product. For example, the oxygen-sensitive product may comprise at least one cut vegetable selected from the group consisting of lettuce, cabbage, broccoli, green beans, cauliflower, spinach, kale, carrot, onion, radish, endive, and escarole where the film has an oxygen transmission rate of from about 3,000 to 10,000 cc (STP)/m²/day/atm at 23° C. and 0% relative humidity.

Aspects of the invention will now be illustrated by the following non-limiting examples.

The various polymeric materials used in the examples below, as well as in comparison film, are set forth below in Table 1.

TABLE 1
Identity of Resins used in the Examples

| | | | | | OTR** | |
|---|---|---|---|---|---|---|
| Generic | | Trade | Density | | (cc (STP)/ | Modulus* |
| Name | Vendor | Name | (g/cc) | Melt Index | m²/day/atm/mil) | (psi) |
| SBS | AMCO | Amalloy | — | — | 18,000 | 250,000 |
| | | B1199 ® | | | | |
| Elastomer₁ | DuPont | Engage ® | 0.868 | 0.5 | 82,000 | 960 |
| | | 8150 | | | | |
| Elastomer₂ | DuPont | Engage ® | 0.870 | 1.0 | 78,000 | 880 |
| | | 8100 | | | | |
| Elastomer₃ | DuPont | Engage ® | 0.857 | 1.0 | 107,000 | — |
| | | 8842 | | | | |
| Elastomer₄ | DuPont | Engage ® | 0.868 | 0.5 | — | 960 |
| | | 8150 | | | | |
| LLDPE | Dow | Dowlex ® | 0.9155 | 3.3 | 7,300 | 35,000 |
| | | 2244G | | | | |
| Elastomer₅ | Dow | Affinity ® | 0.870 | 1.0 | 78,000 | 880 |
| | | EG8100 | | | | |
| Plastomer | Dow | DPF1150 | 0.901 | 0.9 | 17,000 | — |
| HDPE | Equistar | M6020 | 0.957 | 1.9 | 2,800 | 137,000 |

*Data obtained from manufacturer's technical data sheets.
**Unless otherwise indicated, OTR was measured at 23° C. and 0% relative humidity according to ASTM 3985.
The Engage ® elastomers comprise ethylene/alpha-olefin copolymers that were formerly available from DuPont Dow Elastomers and are now available from Dow.

The following Examples are intended to illustrate exemplary embodiments of the invention and it is not intended to limit the invention thereby. Percentages indicated in the examples are % by weight. While certain representative embodiments and details have been shown for the purpose of illustration, numerous modifications to the formulations described above can be made without departing from the invention disclosed.

### EXAMPLES

Six multilayer films were made by a cast line extrusion process. The multilayer film comprised three layers that were coextruded using a Randcastle extruder. The multilayer films were not oriented. Examples 1 through 4 comprise a three layer film having SBS outer layers and a core of a low density ethylene-alpha-olefin copolymer elastomer having a density less than 0.90 g/cc. Example 5 comprises a three layer film having a SBS outer layer, LLDPE sealant layer having a density of 0.9155 g/cc, and a core layer comprising a polyethylene thermoplastic elastomer having a density of 0.868 g/cc. Example 6 comprises a three layer film having a SBS outer layer, a polyethylene plastomer sealant layer having a density of 0.901 g/cc, and a core layer comprising a polyethylene thermoplastic elastomer having a density of 0.868 g/cc.

TABLE 2
Structure and Composition of Multilayer Films of Examples 1-6

| | | Gauge of | | | | |
|---|---|---|---|---|---|---|
| | Composition | Stiffening | | Gauge of | Composition | Gauge of |
| | of Stiffening | Layer | Composition | Core Layer | of Sealant | Sealant Layer |
| | Layer | (mil) | of Core Layer | (mil) | Layer | (mil) |
| Example | SBS | 0.22 | Engage ® | 1.56 | SBS | 0.22 |
| No. 1 | | | 8150 | | | |
| Example | SBS | 0.42 | Engage ® | 1.56 | SBS | 0.42 |
| No. 2 | | | 8150 | | | |
| Example | SBS | 0.42 | Engage ® | 1.56 | SBS | 0.42 |
| No. 3 | | | 8100 | | | |
| Example | SBS | 0.61 | Engage ® | 1.32 | SBS | 0.61 |
| No. 4 | | | 8842 | | | |
| Example | SBS | 0.31 | Engage ® | 1.88 | LLDPE | 0.12 |
| No. 5 | | | 8150 | | | |
| Example | SBS | 0.33 | Engage ® | 1.19 | Plastomer | 0.13 |
| No. 6 | | | 8150 | | | |

TABLE 3
Structure and Composition of Comparative Example

| | Composition | Gauge of | | Gauge of | Composition | Gauge of |
|---|---|---|---|---|---|---|
| | of Outer | Outer Layer | Composition | Core Layer | of Sealant | Sealant Layer |
| | Abuse Layer | (mil) | of Core Layer | (mil) | Layer | (mil) |
| Comparative | HDPE | 0.08 | Elastomer₅ | 2.84 | LLDPE | 0.08 |
| Example | | | | | | |

The film in the comparative example is a prior art film that is commercially available from the Cryovac Division of Sealed Air Corporation and which has previously been used in the packaging fresh seafood. The comparative example film comprised a three layer film having a HDPE abuse layer having a density of 0.957 g/cc, a polyethylene thermoplastic elastomre core layer having a density of 0.870 g/cc, and a LLDPE sealant layer having a density of 0.915 g/cc. The film had a total thickness of about 3 mils.

TABLE 4
Gas and Moisture Vapor Transmission Rates of Examples 1-6 and
Comparative Example

| | | OTR** | CO₂** | | |
|---|---|---|---|---|---|
| | | (cc(STP)/ | (cc(STP)/ | | MVTR¹ |
| | Gauge | m²/day/atm) | m²/day/atm) | CO₂/O₂ Ratio | (g/100 in²/day) |
| Example No. 1 | 2.33 | 12756 | 40030 | 3.14 | 3.01 |
| Example No. 2 | 2.47 | 11149 | 36865 | 3.31 | 2.90 |
| Example No. 3 | 2.43 | 10486 | 34225 | 3.27 | 3.76 |
| Example No. 4 | 2.56 | 5550 | — | — | — |
| Example No. 5 | 2.42 | 9780 | 38532 | 3.94 | 3.01 |
| Example No. 6 | 2.47 | 9992 | 38764 | 3.88 | 2.90 |
| Comparative | 3.09 | 9850 | 26360 | 2.68 | 1.32 |
| Example | | | | | |

*Reflects an average value for two measurements of a given sample.
**Unless otherwise indicated, measured at 23° C. and 0% relative humidity according to ASTM 3985.
¹Moisture Vapor Transmission Rate. Measured according to ASTM F1249.

From Table 4, it can be seen that the multilayer films of the invention have comparable oxygen transmission rates to the film of the comparative example, if not slightly improved in some cases.

TABLE 5
Optical Properties of Examples 1-6 and Comparative Example

| | | Transmission* | Haze* |
|---|---|---|---|
| | Gloss* | (%) | (%) |
| Example No. 1 | 96.3 | 93.6 | 2.05 |
| Example No. 2 | 98.9 | 93.4 | 1.79 |
| Example No. 3 | 83.4 | 93.9 | 2.81 |
| Example No. 4 | 102.5 | 93.3 | 3.29 |
| Example No. 5 | 70.2** | 94.3 | 10.3 |
| Example No. 6 | 94.9** | 93.4 | 2.1 |
| Comparative | 38.5 | 94.1 | 21.5 |
| Example | | | |

*Value reflects an average of three measurements for a given sample.
**Measured from the stiffening layer side of the film.

Table 5 shows that the multilayer film of the invention also possesses improved optical properties over the comparative example film. Specifically, the multilayer films of the invention have a haze value that is generally below about 10%, and Example 6 has a haze value of about 2%. In contrast, the prior art film has a haze value that is greater than 20%.

TABLE 6
Mechanical Properties of Examples 1-6 and Comparative Example

| | | | Elongation | Elongation | Modulus of | Modulus of |
|---|---|---|---|---|---|---|
| | Tensile at Break | Tensile at | at Break | at Break | elasticity | elasticity |
| | along | Break along | long | along | along | along |
| | Longitudinal | Transverse | Longitudinal | Transverse | Longitudinal | Transverse |
| | direction* | direction* | direction* | direction* | direction* | direction* |
| | (psi) | (psi) | (%) | (%) | (psi) | (psi) |
| Example | 2,370 | — | 230 | — | 65,800 | — |
| No. 1 | | | | | | |
| Example | 2,540 | — | 280 | — | 68,500 | — |
| No. 2 | | | | | | |
| Example | 4,680 | — | 170 | — | 134,000 | — |
| No. 3 | | | | | | |
| Example | 3,640 | — | 220 | — | 118,000 | — |
| No. 4 | | | | | | |
| Example | 2,070 | 1,820 | 340 | 480 | 60,600 | 38,700 |
| No. 5 | | | | | | |
| Example | 2,070 | 1,820 | 350 | 500 | 51,600 | 33,300 |
| No. 6 | | | | | | |
| Comparative | 5,620 | 5,650 | 770 | 790 | 8,470 | 8,800 |
| Example | | | | | | |

*Measured according to ASTM D882.

From Table 6, it can be seen that the Examples generally have improved mechanical properties in comparison to the comparative example. In particular, Examples 5 and 6 have a modulus and a percent elongation at break that is significantly improved over that of the comparative example film. Referring back to Table 4, it can be seen that Examples 5 and 6 also have oxygen transmission rates that are comparable to the film of the comparative example. Thus, the multilayer films of the invention provide films having improved mechanical properties while maintaining a desired oxygen transmission rate.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A multilayer film comprising an outer sealant layer, a stiffening layer comprising a thermoplastic styrenic rubber, and at least one inner layer disposed between the outer sealant layer and the stiffening layer, and wherein the film has a modulus of about 15,000 psi or greater in at least one direction, and an oxygen transmission rate of at least 10,000 cc (STP)/m²/day/atm or greater at 23° C. and 0% relative humidity.

2. The multilayer film of claim 1, wherein the outer sealant layer comprises a polymer selected from the group consisting of homogeneous linear low density polyethylene, heterogeneous linear low density polyethylene, heterogeneous very low density polyethylene, ionomer, ethylene vinyl acetate copolymer, ethylene/unsaturated carboxylic acid copolymer, and combinations thereof.

3. The multilayer film of claim 1, wherein the inner layer comprises an ethylene/alpha-olefin copolymer elastomer having a density of less than about 0.895 g/cc.

4. The multilayer film according to claim 1, wherein the multilayer film has an oxygen transmission rate of at least 20,000 cc (STP)/m²/day/atm at 23° C. and 0% relative humidity.

5. The multilayer film according to claim 1, wherein the multilayer film has a modulus of at least 20,000 psi in at least one direction.

6. The multilayer film according to claim 1, wherein the multilayer film has a haze value of less than 6%.

7. A multilayer film comprising:
an outer sealant layer comprising a polymer selected from the group consisting of homogeneous linear low density polyethylene, heterogeneous linear low density polyethylene, heterogeneous very low density polyethylene, ionomer, ethylene vinyl acetate, and combinations thereof;
a stiffening layer comprising a thermoplastic styrenic rubber having sufficient stiffness so that the multilayered film has a modulus of at least 15,000 psi in at least one direction; and
at least one inner layer disposed between the sealant layer and the stiffening layer, the inner layer comprising an ethylene/alpha-olefin copolymer having a density of less than about 0.895 g/cc, and wherein the multilayer film has a thickness greater than 2 mils and an oxygen transmission rate of at least 5,000 cc (STP)/m²/day/atm or greater at 23° C. and 0% relative humidity.

8. The multilayer film according to claim 7, wherein the multilayer film has an oxygen transmission rate of about 8,000 cc (STP)/m²/day/atm or greater at 23° C. and 0% relative humidity, and a modulus of at least 20,000 psi in at least one direction.

9. The multilayer film according to claim 7, wherein the thermoplastic styrenic rubber comprises a styrene/butadiene/styrene block copolymer having a modulus of at least 200,000 psi in at least one direction.

10. The multilayer film according to claim 7, wherein the multilayer film has an elongation at break of less than about 350 percent when measured in the longitudinal direction of the film.

11. The multilayer film according to claim 7, wherein the multilayer film has a modulus of at least 30,000 psi in at least one direction.

12. The multilayer film according to claim 7, wherein the multilayer film has a haze value of less than 5% and a gloss value of greater than about 90.

13. The multilayer film according to claim 7, wherein the multilayer film has an oxygen transmission rate of at least 10,000 cc (STP)/m²/day/atm or greater at 23° C. and 0% relative humidity, and a modulus of at least 30,000 psi in at least one direction.

14. A multilayer film for use in the packaging of oxygen sensitive products, the film comprising:
an outer sealant layer having a density of less than about 0.93 g/cc and being selected from the group consisting of homogeneous linear low density polyethylene, heterogeneous linear low density polyethylene, and heterogeneous very low density polyethylene;
a stiffening layer comprising a thermoplastic styrenic rubber having a modulus of about 200,000 psi or greater in at least one direction; and
a core layer disposed between the sealant and stiffening layers, the core layer comprising an elastomeric ethylene/alpha-olefin having a density of less than about 0.90 g/cc wherein the core layer comprises between about 80 and 95 percent of the film, based on the total thickness of the film, and wherein the film has an oxygen transmission rate of at least 10,000 cc (STP)/m²/day/atm or greater at 23° C. and 0% relative humidity and a modulus of about 20,000 psi or greater in at least one direction.

15. The multilayer film of claim 14, wherein the thermoplastic styrenic rubber is selected from the group of styrene/ethylene/butylenes/styrene copolymer, styrene/butadiene/styrene copolymer, styrene/isoprene/styrene copolymer, and combinations thereof.

16. The multilayer film of claim 14, wherein the multilayer film has an elongation at break between about 350 to 500 percent when measured in the longitudinal direction of the film.

17. The multilayer film of claim 12, wherein the multilayer film has a haze value of less than 4%.

18. A packaged product comprising:
an oxygen-sensitive product; and
a package substantially surrounding the oxygen-sensitive product, the package comprising a multilayer film having a thickness of from about 2 to 5 mils, the multilayer film comprising a core layer disposed between first and second outer layers, wherein:
the first outer layer comprises a polyethylene having a density of less than 0.93 g/cc;
the second outer layer comprises a thermoplastic styrenic rubber having a modulus of at least 200,000 psi; and
the core layer comprises a polymer consisting of an ethylene/alpha-olefin copolymer having a density of less than about 0.90 g/cc, and wherein the multilayer film has an oxygen transmission rate of at least 10,000 cc (STP)/m²/day/atm or greater at 23° C. and 0% relative humidity and a modulus of at least 20,000 psi in at least one direction.

19. The packaged product of claim 18, wherein said package is formed by a vertical form-fill-seal process.

20. The produce package of claim 18, wherein the oxygen-sensitive product comprises seafood.

21. The packaged product of claim 18, wherein the oxygen-sensitive product comprises a vegetable.

22. A bag comprising a multilayer film heat sealed to itself or another film, the multilayer film comprising:
an outer sealant layer having a density of less than 0.93 g/cc, and comprising a polymer selected from the group consisting of homogeneous linear low density polyethylene, heterogeneous linear low density polyethylene, heterogeneous ultra low density polyethylene, heterogeneous very low density polyethylene, ionomer, ethylene vinyl acetate, and combinations thereof;
a stiffening layer comprising a styrenic thermoplastic elastomer having a modulus of at least 200,000 psi; and
a core layer disposed between the sealant layer and the stiffening layer, the core layer comprising an elastomeric ethylene/alpha-olefin copolymer having a density of less than about 0.90 g/cc, and wherein the multilayer film has oxygen transmission rate of at least 10,000 cc (STP)/m²/day/atm or greater at 23° C. and 0% relative humidity and a modulus of at least 15,000 psi in at least one direction.

23. The bag according to claim 22, wherein the multilayer film has a haze value of less than 10%.

24. The bag according to claim 22, wherein the bag is an end-seal bag.

25. The bag according to claim 22, wherein the bag is a side-seal bag.

26. The bag according to claim 22, wherein the bag is oriented in at least one direction.
